(19) United States
(12) Patent Application Publication
(10) Pub. No.: US 2002/0074288 A1
(43) Pub. Date: Jun. 20, 2002

(54) Iodine resins

(76) Inventors: Michael Happ, Dormagen (DE); Werner Struver, Leverkusen (DE); Reinhold Klipper, Koln (DE); Ulrich Schnegg, Leverkusen (DE); Hans-Karl Soest, Koln (DE); Helmut Schaffrath, Bergheim (DE)

Correspondence Address: BAYER CORPORATION, PATENT DEPARTMENT, 100 BAYER ROAD, PITTSBURGH, PA, 15205, US

(21) Appl. No.: 10/017,344

(22) Filed: Dec. 14, 2001

(30) Foreign Application Priority Data
Dec. 19, 2000 (DE) 10063299.8

(51) Int. Cl. B01D 15/00

(52) U.S. Cl. 210/660

(57) ABSTRACT

The present invention relates to a process for preparing monodisperse ion exchangers having polyiodide groups, the resins themselves and their use for drinking water treatment and drinking water disinfection.

### BACKGROUND OF THE INVENTION

The present invention relates to a process for preparing mono-disperse ion exchangers having polyiodide groups, the iodine resins themselves, and their use for drinking water disinfection or drinking water treatment.

The lack of clean water is by far the greatest international health problem. According to the WHO (World Health Organization) approximately 50,000 people die daily of diseases caused by contaminated water.

One possible method of disinfecting drinking water is the use of ion exchange resins that permit halogens to be stored and released again in a targeted manner. Iodine is suitable as preferred halogen in small POU systems. The resin should be such that it releases small amounts of iodine in a controlled manner and over a relatively long period. Iodine is bound to the resin ionically via quaternary ammonium groups as triiodide, pentaiodide, heptaiodide, and, if appropriate, higher-iodinated polyiodides.

When the iodine resins are prepared, iodine incrustations must be avoided. These incrustations prevent uniform charging of the resin with iodine and are washed out first on use. This leads to an excessive initial iodine release and to rapid decrease in iodine concentration down to low values. Users of apparatus for water disinfection have reported numerous examples in which such resins were used that led to high iodine contents, (>10 ppm) in the treated water (U.S. Pat. No. 4,238,477 at column 1, lines 41-55).

U.S. Pat. Nos. 3,817,860 and 3,923,665 describe the disinfection of water using a bactericide based on strongly basic heterodisperse ion exchangers having polyiodide groups. Triiodide is mentioned as the only usable polyiodide. Higher polyiodide ions bound to strongly basic ion exchangers release iodine into the solution. The strongly basic resin in the commercially conventional chloride or sulfate form is admixed batchwise or in a column with a one molar aqueous potassium iodide solution that contains potassium iodide and iodine in a ratio of 3.5:1 (mol/mol). Here, iodine is used substoichiometrically, based on the capacity of the strongly basic resin (70 to 80% are sufficient, 96 to 98% are mentioned in the examples). The strongly basic resin, before the treatment with the potassium iodide/iodine solution, can also be converted into the iodide form in the column using potassium iodide solution. The resin that has reacted with the triiodide solution is then thoroughly washed with distilled water. Optionally, before the water wash, the resin, to remove excess iodine and polyiodides higher than triiodide, can be treated with potassium iodide solution.

U.S. Pat. Nos. 4,187,183 and 4,190,529 describe heterodisperse mixed-form polyhalide resins for disinfecting water and their use. The resins are obtained by reacting a strongly basic anion exchange resin, preferably in the chloride form, with a mixture of halogen and halide salt in water. The anions of the disinfection resin consist of mixtures of trihalides and pentahalides (halogen: iodine and/or bromine). In contrast to U.S. Pat. Nos. 3,817,860 and 3,923,665, the molar ratio of halogen to halide is always less than 1 and the preferred amount of halide is less than the stoichiometric amount required for complete loading at all points on the resin.

U.S. Pat. No. 4,238,477 describes the production of homogeneous heterodisperse polyiodide resin disinfectants. A commercial strongly basic anion exchange resin is converted from the chloride form into the iodide form using a KI excess (20 to 100 mol %). Then, from a separate vessel, iodine is circulated by pumping over the iodide resin using warm salt-free water until the iodine is completely dissolved and has been taken up by the resin. Because of the low solubility of iodine in water (0.3 g/L at 25° C. and 0.78 g/L at 50° C.), relatively high temperatures (>40° C., for commercial purposes 60 to 95° C.) and long reaction times are necessary. At higher temperatures, iodine sublimation is already notable, which leads to problems in handling and with exact charging. The process is restricted to the production of small amounts (U.S. Pat. No. 4,999,190 at column 2, lines 36 to 46).

U.S. Pat. No. 4,999,190 describes the direct production of a hetero-disperse polyiodide resin that contains pentaiodide and triiodide groups by addition of a strongly basic anion exchange resin in the chloride form a little at a time to a polyiodide solution. The polyiodide solution is prepared by dissolving potassium iodide in water at 45° C. (8 to 10 molal) and then adding sufficient iodine to form a solution which contains triiodide and pentaiodide ions (8 to 10 molal). At least 50% of the polyiodide ions are pentaiodide. At elevated temperature (30 to 60° C.), a moist strongly basic anion exchange resin in the chloride form is added a little at a time and the reaction mixture is stirred. After the reaction is terminated, the iodinated resin is washed with distilled water.

U.S. Pat. No. 4,420,590 describes the batchwise production of a bactericidal heterodisperse resin by reacting a strongly basic anion exchange resin with iodine, potassium iodide, potassium bromide, and the disinfection of water therewith. In contrast to U.S. Pat. No. 3,817,860, a small part (8 to 25%) of the potassium iodide is replaced by potassium bromide and only 60% of the amount of resin of U.S. Pat. No. 3,817,860 is used. The amount of halogen released (iodine and bromine plus their ions) is reduced to approximately 15 to 25%, compared with U.S. Pat. No. 3,817,860.

U.S. Pat. No. 5,431,908 describes the production of a heterodisperse polyhalide resin disinfectant. A strongly basic anion exchange resin is first brought into the iodide or bromide form and then charged at room temperature, in circulation, with an aqueous polyhalide solution (preferably polyiodide). Resin and polyhalide solution are in two separate vessels.

All of the ion exchange resins described in the prior art that are used for water disinfection are of heterodisperse or polydisperse nature, which is to say that they have a broad particle size distribution, associated with the disadvantages of pressure drops, low flow rates, low exchange rates, especially contact times becoming longer during use, and reduced mechanical and osmotic stability in drinking water treatment plants and drinking water disinfection plants.

The market requires ion exchange resins that do not have the above-mentioned disadvantages and thus ensure drinking water disinfection and drinking water treatment without problems over a relatively long period.

This object is achieved by using monodisperse strongly basic anion exchangers having polyiodide groups for drinking water disinfection and drinking water treatment, which anion exchangers can be produced directly, even on an industrial scale, from the strongly basic form of the anion exchange resin supplied (generally chloride form or sulfate form), for which iodine loading can be varied, that have a long activity for drinking water disinfection, and that can be used even in waters having high salt contents.

### SUMMARY OF THE INVENTION

The present invention therefore relates to a process for preparing monodisperse strongly basic anion exchangers having polyiodide groups comprising

(A) charging monodisperse strongly basic anion exchange resins into water in a vessel,

(B) preparing in a second vessel a mixture of iodine, iodide salt, and water, and

(C) circulating the aqueous phase from step (B) over the resin until all iodine crystals are dissolved.

### BACKGROUND OF THE INVENTION

The monodisperse iodine resins produced according to the inventive process have an iodine content between 450 and 600 g per liter of iodine resin, preferably between 480 and 550 g per liter of iodine resin. The iodine release after elution with 2 to 4 liters of model water is in the region of 3 to 7 ppm of iodine, the iodide content is less than 4 ppm.

Suitable monodisperse strongly basic gel-form anion exchangers for process step (A) are described, for example, in EP-A 1,000,660.

These monodisperse gel-form strongly basic ion exchangers are obtained by a process having the steps

(a) forming a suspension of seed polymer in a continuous aqueous phase,

(b) swelling the seed polymer in a monomer mixture of vinyl monomer, crosslinker and free-radical initiator,

(c) polymerizing the monomer mixture in the seed polymer, and

(d) functionalizing the copolymer formed by chloromethylation and subsequent amination,

wherein the seed polymer is a crosslinked polymer having a swelling index of 2.5 to 7.5 (measured in toluene) and having a non-volatile soluble content (measured by extraction with tetrahydrofuran) of less than 1% by weight.

In a particular embodiment of the process according to EP-A 1,000,660, the seed polymer used is a crosslinked polymer produced from

(i) 96.5 to 99.0% by weight of monomer,

(ii) 0.8 to 2.5% by weight of crosslinker, and

(iii) 0.2 to 1.0% by weight of aliphatic peroxy esters as polymerization initiator.

Monomers (i) for preparing the seed polymer are compounds having one C═C double bond per molecule that can be polymerized by a free-radical mechanism. Preferred compounds of this type include aromatic monomers, for example, vinyl and vinylidene derivatives of benzene and of napthalene, for example, vinyinaphthylene, vinyltoluene, ethylstyrene, α-methylstyrene, chlorostyrenes, and preferably styrene, and nonaromatic vinyl and vinylidene compounds, for example, acrylic acid, methacrylic acid, acrylic acid C₁-C₈ alkyl esters, methacrylic acid C₁-C₈ alkyl esters, acrylonitrile, methacrylonitrile, acrylamide, methacrylamide, vinyl chloride, vinylidene chloride, and vinyl acetate, and mixtures of these monomers. Preferably, the nonaromatic monomers are used in subsidiary amounts, preferably in amounts of 0.1 to 50% by weight, particularly 0.5 to 20% by weight, based on aromatic monomers. In most cases, however, exclusively aromatic monomers are used.

Suitable crosslinkers (ii) are compounds that contain two or more (preferably two to four) double bonds per molecule that can be polymerized in a free-radical manner. Crosslinkers that may be mentioned by way of example are divinylbenzene, divinyltoluene, trivinylbenzene, divinylnaphthalene, trivinylnaphthalene, diethylene glycol divinyl ether, octa-1,7-diene, hexa-1,5-diene, ethylene glycol dimethacrylate, triethylene glycol dimethacrylate, trimethylolpropanetrimethacrylate, allyl methacrylate, and methylene-N,N′-bisacrylamide. Divinylbenzene is preferred as crosslinker. For most applications, commercial divinylbenzene quality grades that also contain ethylvinylbenzenes and naphthalene, in addition to the divinylbenzene isomers, are sufficient.

Aliphatic peroxyesters (iii) for preparing seed polymers correspond to the formulas I, II, or lIl

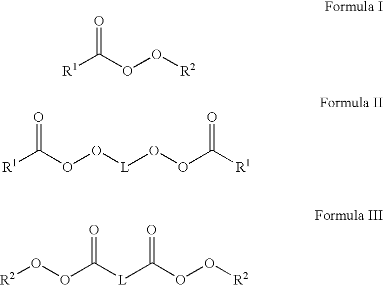

where

R¹ represents an alkyl radical having 2 to 20 carbon atoms or a cycloalkyl radical having up to 20 carbon atoms,

R² represents a branched alkyl radical having 4 to 12 carbon atoms and

L represents an alkyl radical having 2 to 20 carbon atoms or a cycloalkylene radical having up to 20 carbon atoms.

In the process for producing the monodisperse gel-form strongly basic ion exchangers according to co-pending patent application U.S. Ser. No. 09/434,337, filed Nov. 4,1999, in addition, inhibitors can be added or the components to produce the seed polymer can be microencapsulated. According to Example 2(a) of co-pending patent application U.S. Ser. No. 09/434,337 the seed polymer is prepared as follows:

To 1960 ml of deionized water introduced into a 4 liter glass reactor were added 630 g of a microencapsulated mixture of 1.0% by weight of divinylbenzene, 0.6% by weight of ethylstyrene (used as a commercially available mixture of divinylbenzene and ethylstyrene containing 63% by weight of divinylbenzene), 0.5% by weight of tert-butyl peroxy-2-ethylhexanoate, and 97.9% by weight of styrene, where the microcapsule consisted of a formaldehyde-hardened complex coacervate of gelatin and an acrylamide-acrylic acid copolymer. The mean particle size was 231 μm. A solution of 2.4 g of gelatin, 4 g of sodium hydrogen phosphate dodecahydrate, and 100 mg of resorcinol in 80 ml of deionized water was added to the mixture, which was stirred slowly and polymerized for 10 hours at 75° C. with stirring. The polymerization was then completed by increasing the temperature to 95° C. The batch was washed through a 32 μm sieve and dried, giving 605 g of a spherical, microencapsulated polymer having a smooth surface. The polymers appeared optically transparent; the mean particle size was 220 μm. The seed polymer has a volume swelling index of 4.7 and a soluble content of 0.45%.

Therefore, the contents of co-pending patent application U.S. Ser. No. 09/434,337 are incorporated in the present application.

In addition to these gel-form resins, however, macroporous ion exchangers, as produced, for example, in accordance with DE-A 199 40 864, can be used. In these exchangers, a porogen is added during the polymerization. A porogen is taken to mean a chemical substance that is miscible with the monomers but does not dissolve or swell the resulting polymers. The exchange resins are used in the salt form in process step (A). Preferred counterions are chloride, sulfate, or hydroxide, particularly preferably chloride. As a variant, the resin can also be converted into the iodide form before the iodination.

For the iodination, the iodide salts used can be alkali metal iodides, ammonium iodides, or alkaline earth metal iodides. Preferably, potassium iodide, sodium iodide, and ammonium iodide, particularly preferably potassium iodide, are used.

Per mol of strongly basic anion exchange resin in the salt form, in process step (B), in a second vessel, 0.7 to 2.0 mol of iodide (preferably 1.0 to 1.5 mol of iodide, particularly preferably 1.05 to 1.15 mol of iodide) and 0.9 to 3.0 mol of iodine (preferably 1.0 to 2.0 mol of iodine, particularly preferably 1.2 to 1.6 mol of iodine) are used.

The amount of demineralized water in process steps (B) and (C) is not critical. However, resin and iodine in both vessels should always be covered with liquid. It is recommended that the connection tubes between the two vessels are closed with a screen or a frit in order to avoid unwanted mixing of the resin and iodine crystals (with a risk of iodine incrustations on the resin). The resin is loaded with the polyiodide solution in process step (C) between 10 and 90° C., preferably between 20 and 60° C., particularly preferably between 35 and 50° C. Step (C) is ended when all iodine crystals have dissolved and the color of the aqueous solution, which at the beginning is deep violet, has lightened via reddish-brown, to yellow. From the economic aspect, an endpoint is defined by a limiting value of iodine content. It has been found that below a limiting value of 250 ppm of iodine, the iodination process is uneconomic. In order to save expensive iodine and iodide, the reaction solution can be added via fresh resin (optimally in a column). Iodine and iodide are virtually quantitatively taken up (see Example 1).

The iodine resins obtainable by the inventive process have considerable advantages in comparison with the resins of the prior art.

The most important advantages are, in particular, but not exclusively, in industrial water treatment plants, for example, drinking water disinfection plants:

Lower pressure drop, associated therewith higher flow rates when operating under hydrostatic pressure, higher resin beds, smaller vessel diameters, decreased space requirement, reduction of capital costs in industrial drinking water treatment plants.

Higher utilizable capacity, lower intrinsic water requirement during plant start-up, lower resin requirement.

Higher exchange rate permits very short contact times, very sharp loading front, associated therewith reduction in the minimum working bed height.

High mechanical and osmotic stability permit high service life and extreme loadings.

The inventive ion exchange resins having polyiodide groups can be used, for example, for disinfecting drinking water, for instance in municipal, industrial, or domestic drinking water treatment systems.

The inventive resins can be used for disinfecting desalinated, partially desalinated, or non-desalinated water. Softened or partially softened waters can also be disinfected using the inventive resins.

Disinfected waters of this type are used both in the conventional domestic sector and also in industrial applications. Special requirements are made of disinfected water by, in particular, medical care facilities, for example, hospitals, first aid stations, emergency relief teams, field hospitals, or the pharmaceutical industry. Here, the requirements for sterile water can be met even under difficult conditions using the inventive iodine resins.

In addition to the disinfecting action of the resins, these resins can also be used in the chemical industry in reactions in the presence of iodine or polyiodide.

Examples that may be mentioned here are iodinations of chemical compounds, preferably aromatics or alkyl compounds.

The inventive resins can be used not only on an analytical and laboratory scale but also on an industrial or large scale. Their use is independent of the order of magnitude and depends only on the relationship between the amount of resin, working height, and/or flow rate on the one hand and extent of infection on the other.

Expediently, the ideal relationship is determined by preliminary experiments. Examples 1 and 2 give an indication of dimensioning.

Preparation of the inventive ion exchange resins is to be described with reference to the examples hereinafter. The invention, which is set forth in the foregoing disclosure, is not to be limited either in spirit or scope by these examples. Those skilled in the art will readily understand that known variations of the conditions of the following procedures can be used. Unless otherwise noted, all temperatures are degrees Celsius and all percentages are percentages by weight.

### EXAMPLES

### Example 1

Apparatus:

1 liter reservoir vessel (thermostatable) with agitator, temperature sensor, glass frit tube, and thermostat

1 liter reaction vessel with agitator, inlet at the bottom, and outlet at the top (both with glass frit)

Pump

500 ml column for purifying the reaction solution

0.5 mol (400 ml) of monodisperse strongly basic anion exchanger in the chloride form (from EP-A 1,000,660, Example 2) was charged into the reaction vessel and the vessel was filled with 600 ml of deionized water. 0.5 mol (83 g) of potassium iodide and 600 ml of deionized water were added to the reservoir vessel and stirred. A clear solution formed. Then 0.67 mol (170 g) of iodine were added. The iodine crystals dissolved to only a small extent at the beginning and covered the bottom. The frit tube was arranged at a height such that it dipped into the solution but did not come into contact with the iodine. The aqueous solution was warmed to 40° C. with stirring. Then the intensely violet solution was begun to be circulated by pumping. During the reaction, both vessels were stirred. The reaction vessel could, but need not be, heated. However, without heating due to the pumped circulation it can virtually reach the temperature of the iodine/iodide reservoir. After approximately 3.5 h, the iodine sediment had disappeared in the reservoir and the polyiodide solution then began to lighten. After 5 h, the reaction was terminated. The color of the solution was yellow. The iodine content of the solution was 81 ppm, the iodide content was 483 ppm, and the chloride content was 1.23%.

The finished resin was washed with 12 liters of deionized water in a column.

Volume of iodine resin: 318 ml.

Total iodine content: 494.8 g of iodine/liter of iodine resin.

Elution with Salt-containing Model Water

After 3.5 liters: 5.9 ppm of iodine, 2.0 ppm of iodide

After 189 liters: 2.9 ppm of iodine, 2.6 ppm of iodide.

The reaction solution (1000 ml) was applied to 50 ml of fresh resin (chloride form) in a column. Iodine and iodide were taken up by the resin. The top layer of the resin was brown. 1000 ml of effluent water contained 0.017 ppm of iodine, 0.030 ppm of iodide, and 1.13% of chloride.

Analytical Methods

a) Total iodine content of the resin

10 ml of the iodine resin were eluted in a column with 500 ml of 2 m NaOH and at a rate of 1 ml/min. 10 ml of the eluate were acidified with 10 ml of HCl, 1 ml of starch solution was added, and the eluate was titrated with 0.1 M sodium thiosulfate solution until the blue color disappeared.

b) Iodine and iodide content in the ppm range (Leucocrystal violet method according to AWWA Standard Methods, 17^{th} Edition, 4-102, 4-107)

Iodine was oxidized by mercury (II) ions to hypoiodide. This oxidizes colorless leucocrystal violet [4,4′,4″-tri(N,N-dimethylaniline)methane] to a violet dye. The iodine concentration was determined photometrically. The absorption maximum of the dye is at 592 nm in a pH range of 3.5 to 4.0. Iodide was oxidized by potassium monopersulfate to iodine and determined as such.

c) Test with salt-containing model water

25 ml of iodine resin were eluted in a column with water (2 liters/h) which contained 300 ppm of chloride and 200 ppm of hydrogen carbonate, both as sodium salts.

### Example 2

0.5 mol (382 ml) of monodisperse strongly basic anion exchanger in the chloride form (from EP 1,000,660, Example 2) was charged into the reaction vessel and the vessel was filled with 600 ml of deionized water. 0.543 mol (90.1 g) of potassium iodide and 600 ml of deionized water were added to the reservoir vessel and stirred. A clear solution formed. Then, 0.709 mol (180 g) of iodine were added. The iodine crystals dissolved only to a small extent at the start and covered the bottom. The frit tube was arranged at a height so that it dipped into the solution but did not come into contact with the iodine. The aqueous solution was first pumped with stirring for 2 h at room temperature onto the resin. During the reaction, both vessels were stirred. Then, in the course of 2 h, the reservoir vessel was brought to 43° C. and circulation by pumping was continued for a further 16 h at 43° C.. The color of the solution was light brown. The iodine content of the solution was less than 10 ppm. The finished resin was washed with 8 liters of deionized water in a column.

Volume of iodine resin: 300 ml.

Total iodine content: 544 g of iodine/liter of iodine resin.

Elution with Salt-containing Model Water

After 4 liters: 3.3 ppm of iodine, 2.1 ppm of iodide.

### Example 3

### Comparison Example

0.5 mol (400 ml) of monodisperse strongly basic anion exchanger in the chloride form (from EP-A 1,000,660, Example 2) was converted into the iodide form in the column by 1 mol (166 g) of potassium iodide in 2000 ml of deionized water and washed with 20 bed volumes of deionized water. Yield: 285 ml of resin in the iodide form.

The resin in the iodide form was charged into the reaction vessel of Example 1 and the vessel was filled with deionized water. 0.584 mol (148.3 g of iodine and 400 ml of deionized water) were charged into the reservoir vessel of Example 1 and heated to 70-72° C. Only the iodine-containing aqueous solution without iodide was circulated over the resin by pumping. After 19 h, no iodine crystals could be observed in the reservoir vessel, and the aqueous solution was pale brown. After 23 h, the reaction was terminated. The iodine content was less than 10 ppm. The resin was finally washed with deionized water.

Volume of iodine resin: 260 ml

Total iodine content: 510 g of iodine/liter of iodine resin

Elution with Salt-containing Model Water

After 4 liters: 0.2 ppm of iodine, 1.7 ppm of iodide

After 35 liters: 0.2 ppm of iodine, 1.6 ppm of iodide

The iodine release was thus too low for use for disinfecting drinking water.

### Example 4

### Comparison Example

0.628 mol (400 ml) of commercially conventional heterodisperse strongly basic anion exchanger in the chloride form such as Lewatit M 500® was converted into the iodide form in the column by 1.256 mol (208.5 g of potassium iodide in 1000 ml of deionized water) and washed with 20 bed volumes of deionized water. Yield: 320 ml of resin in the iodide form.

The resin in the iodide form was stirred in a 6 liter glass reactor equipped with an agitator at room temperature with 0.84 mot (139.7 g) of potassium iodide and 0.757 mol (192 g) of iodine in 4 liters of deionized water for 48 h at room temperature. The resin was then eluted in a column with deionized water until the effluent was clear.

Volume of iodine resin: 325 ml

Total iodine content: 540 g of iodine/liter of iodine resin.

Elution with Salt-containing Model Water

After 2 liters: 1.7 ppm of iodine, 6.5 ppm of iodide

The iodine release was too low, but the iodide release was too high, for use for disinfecting drinking water.

At an initial iodine release less than 3 ppm, the disinfecting action was too low, and, with a release of >4 ppm of iodide, the iodide/iodine trap connected downstream in many iodine resin cartridges was exhausted too rapidly.

What is claimed is:

1. A process for preparing monodisperse strongly basic anion exchangers having polyiodide groups comprising
(A) charging a monodisperse strongly basic anion exchanger resin into water in a vessel,
(B) preparing in a second vessel a mixture of iodine, iodide salt, and water, and
(C) circulating the aqueous phase from step (B) over the resin until all iodine crystals are dissolved.

2. A process according to claim 1 wherein the monodisperse strongly basic anion exchange resin used in step (A) is a gel-form or macroporous resin.

3. A process according to claim 1 wherein a salt form of the monodisperse strongly basic anion exchange resin is used in step (A).

4. A process according to claim 1 wherein the iodide salt used in process step (B) is an alkali metal iodide, ammonium iodide, or alkaline earth metal iodide.

5. A process according to claim 1 wherein 0.7 to 2.0 mol of iodide per mol of the strongly basic anion exchanger in salt form are used.

6. A process according to claim 1 wherein the resin is loaded with the polyiodide solution at temperatures between 10 and 90° C.

7. A monodisperse strongly basic anion exchange resin having polyiodide groups obtained by
(A) charging a monodisperse strongly basic anion exchanger into a vessel with water,
(B) preparing a mixture of iodine, iodide salt, and water in a second vessel, and
(C) circulating the aqueous phase from step (B) over the resin until all iodine crystals are dissolved.

8. A resin according to claim 7 having an iodine release of 3 to 7 ppm and an iodide release of less than 4 ppm.

9. A method for disinfecting or treating drinking water comprising exposing water in need of disinfection or treatment to a monodisperse strongly basic anion exchange resin having polyiodide groups according to claim 7.

10. A method for disinfecting water used in the household sector, in the pharmaceutical industry, in the chemical industry, or in medical care facilities comprising exposing such water to a monodisperse strongly basic anion exchange resin having polyiodide groups according to claim 7.

11. A method comprising carrying out chemical reactions in the presence of iodine or polyiodide obtained using a monodisperse strongly basic anion exchange resin having polyiodide groups according to claim 7.
